(19) United States
(12) Patent Application Publication
(10) Pub. No.: US 2026/0206731 A1
(43) Pub. Date: Jul. 23, 2026

(54) FISHING DEVICE

(71) Applicant: Bodie RANDALL, Queensland (AU)

(72) Inventor: Bodie RANDALL, Queensland (AU)

(21) Appl. No.: 19/139,993

(22) PCT Filed: Jan. 4, 2024
(86) PCT No.: PCT/AU2024/050002

§ 371 Date: Jun. 17, 2025

(30) Foreign Application Priority Data
Feb. 16, 2023 (AU) 2023900388

(51) Int. Cl. A01K 83/06

(52) U.S. Cl. CPC A01K 83/063; A01K 83/064

(57) ABSTRACT

A fishing device adapted for securing bait, the fishing device comprising: a first elongate member parallel to a second elongate member, wherein the first elongate member and the second elongate member are each connected to a respective end of a biasing spring at a first end; and wherein the first elongate member and the second elongate member each has a first hook and second hook formed at a second end respectively; a crossing region between the first elongate member and the second elongate member, wherein the crossing region separates each elongate member into a shank portion and a handle portion; a first group and a second group of teeth, wherein the first group of teeth from the first shank portion is protruding towards the second shank portion, and wherein the second group of teeth from the second shank portion is protruding towards the first shank portion.

### TECHNICAL FIELD

The present invention relates to a fishing device, more particularly a fishing hook with a bait retaining mechanism.

### BACKGROUND

The use of bait with typical fishhook and a long shank is particularly common in fishing. These types of fishing hook require an angler to carefully hold the bait, orientating the bait such that the point of the hook enters through the head or mouth region and into and out of the bait's body. As bait can be small and slippery, a disadvantage with these typical fishing hooks is that the angler's fingers gripping and guiding small baits can easily be pricked or punctured accidentally when impaling or securing the bait to the hook for fishing. Further, as casting the line to the water requires a sudden flinging motion, baits impaled through these typical fishing hooks can easily dislodge in this motion or flung out of the hook before the fish hook enters the water and it is until after a considerable time in waiting that the angler winds up the fishing line until the typical hook is out of the water that the angler can see that the hook is without bait.

Examples of devices designed to hold bait and lures include U.S. Pat. Nos. 5,611,168 and 10,143,188, which discloses generally to fishing lures with teeth which consists of upper and lower cylindrical jaws. However, this device relies on the jaws to be releasable by pulling the legs or jaws outward from one another to disengage the impaling teeth from the bait. As sharp teeth for the purposes of retaining bait is located at the jaws, a disadvantage is that it also has a risk that the angler's fingers may be punctured by the teeth.

Other examples include U.S. patent application Ser. No. 10/604,937 which is directed to a fish hook with a bait attachment clip. The clip is coupled to the hook and a flexible sleeve can removably couple the bait attachment clip in an operative position. However, the bait is not impaled by the clip and the disadvantage of this device is that they do not sufficiently hold and prevent loss of bait.

Any discussion of the prior art throughout the specification should in no way be. considered as an admission that such prior art is widely known or forms part of common general knowledge in the field.

### SUMMARY

### Problems to be Solved

It may be an advantage to provide a fishing device that easily allows a person to place and secure the bait.

It may be another advantage to provide a handle portion that can affect the opening of the shank portions with baiting retaining teeth so that a person's fingers would not be near the teeth when putting the bait to the bait receiving zone.

It may be another advantage to provide a fishing device that has a group of teeth for impaling or securing the bait when placed in the bait receiving configuration or open configuration 128 and to minimise the risk of a person accidentally puncturing their fingers when baiting the hook.

It may be another advantage to provide a fishing device that has a curved shank portions forming convex shape for better receiving the bait and for securing the bait.

It may be another advantage to provide a fishing device with a biasing spring that can be chosen in terms of its size in relation to tension for the desired type of bait used.

It may be another advantage to use the eye of the biasing spring as a means for allowing a fishing line to be tied therethrough to secure the fishing device to the fishing line.

It may be another advantage to use the inline ‘J’ hooks for complying with many local or state fishing regulations.

It may be another advantage to use stainless steel hooks for reusability, as it does not rust.

It may be another advantage to construct the fishing device in other rustable materials for complying with local or state fishing regulations.

It may be another advantage to have two hooks so as to increase snaring and catching the fish.

It may be another advantage to have barbs on the hooks so as to also increase snaring and catching the fish.

It may be another advantage to have different handle length portions to tailor the force that a person can squeeze or pinch to go from a closed configuration to an open configuration.

It may be another advantage to have a retaining element at the crossing region so as to keep the elongate members together.

It may be another advantage to secure the bait between the shank portions, in which the secured bait is presented in a natural swimming position for enticing fish to bite by resembling the natural movements of the bait and/or movements of the struggling bait.

It may be another advantage to provide a fishing device that reduces snag or snag resistant from the hook positioning at the second end of the fishing device. The hook positioning faces upwards thereby creating less hook drag.

It may be another advantage to provide confidence and ease of use for an angler to secure bait to the fishing device without the need to know the right ways to thread bait to a hook.

It is an object of the present invention to overcome or ameliorate at least one of the disadvantages of the prior art, or to provide a useful alternative.

### Means for Solving the Problem

A first aspect of the present invention may relate to a fishing device adapted for securing bait, the fishing device comprising a first elongate member parallel to a second elongate member, wherein the first elongate member and the second elongate member are each connected to a respective end of a biasing spring at a first end; and wherein the first elongate member and the second elongate member each has a first hook and second hook formed at a second end respectively. A crossing region between the first elongate member and the second elongate member, wherein the crossing region separates each elongate member into a shank portion and a handle portion. A first group and a second group of teeth each group comprising at least one tooth adapted for securing bait, wherein the first group of teeth from the first shank portion is protruding towards the second shank portion, and wherein the second group of teeth from the second shank portion is protruding towards the first shank portion.

Preferably, the device is operable between an open configuration and a closed configuration, wherein the open configuration is effected by applying a squeezing force to the handle portion which moves the shank portions away from each other for allowing a bait to be received between the groups of teeth, and wherein releasing the squeezing force, the biasing spring biases the shank portions towards each other such that the teeth secures the received bait.

Preferably, the first group of teeth from the first shank portion is protruding at an angle towards the second shank portion, and wherein the second group of teeth from the second shank portion is protruding at an angle towards the first shank portion.

Preferably, the tooth may be protruding at an angle from each of the facing surfaces towards each other in the same plane.

Preferably, the angle may be perpendicular from each of the facing surfaces towards each other in the same plane.

More preferably, the angle is perpendicular from the first shank portion towards the second shank portion.

Preferably, the protrusion of the tooth from each of the facing surfaces is in line with respect to each other.

More preferably, the protrusion of the first group of teeth is in line with respect to the second group of teeth.

Preferably, the protrusion of the tooth from each of the facing surfaces is offset with respect to each other.

More preferably, the protrusion of the tooth from the first group of teeth is offset with respect to the second group of teeth.

Preferably, the first group of teeth is protruding at an acute angle from the first shank portion, and wherein the second group of teeth is protruding at an acute angle from the second shank portion.

Preferably, the tooth is protruding at an obtuse angle from each of the facing surfaces towards each other in the same plane, wherein the direction of protrusion away from the second end.

More preferably, the first group of teeth is protruding at an obtuse angle from the first shank portion, and wherein the second group of teeth is protruding at an obtuse angle from the second shank portion.

Preferably, the first group of teeth is equally spaced from each other, and the second group of teeth is equally spaced from each other, and wherein the length of the teeth protrusion decreases from the second end to the crossing region.

Preferably, the biased spring is a coiled portion, wherein the profile of the eye of the coil is in the same longitudinal plane as the device.

Preferably, the coiled portion has one or more rings, wherein the profile of each ring is in the same plane as the longitudinal axis of the device.

Preferably, the eye of the coil may be adapted to receive a fishing line therethrough.

Preferably, the size of the coil can be of a predetermined diameter for allowing the fishing device to be used in a range of tensions.

Preferably, the handle portion can be of a predetermined length for allowing the fishing device to be used in a range of pinching or squeezing forces for moving from the closed configuration to an open configuration.

Preferably, the biased spring has a first end and a second end, wherein the first end of the first elongate member is in connection to the second end of the biased spring, and wherein the first end of the second elongate member is in connection to the first end of the biased spring.

Preferably, the length of the first shank portion and the length of the second shank portion is curved.

More preferably, the length of the first shank portion and the length of the second shank portion has a convex profile.

Preferably, the fishing device is constructed from a material selected from the group of: stainless steel, high-carbon steel, steel alloyed with vanadium, and galvanized steel.

Preferably, the first hook and the second hook each comprises a barb protruding from the surface of the hook.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a perspective view of a fishing device of the present invention;

FIG. 2 illustrates a perspective view of the fishing device of FIG. 1 when in a bait receiving configuration or an open configuration.

FIG. 3 illustrates a perspective view of the fishing device of FIG. 2 when in a secured configuration or a closed configuration.

FIG. 4 illustrates a perspective view of the fishing device in a bait receiving configuration showing a hand of a person applying a pinching force to the handle portion of the shank and the other hand placing a bait between the bait securing shank portions of the device.

FIG. 5 illustrates a perspective view of a bait being received and secured between the bait securing shank portions showing the at least one tooth impaling and securing the bait, when the person releases the pinching force to the handle portion of the shank.

FIG. 6 illustrates a perspective view of a bait such as a prawn being received between the hook ends and secured by the teeth along the bait securing shank portion.

FIG. 7 illustrates a perspective view of another bait such as a fish being received between the hook ends and secured by the teeth along the bait securing shank portion.

FIG. 8 illustrates a perspective view of another bait such as a plastic bait or soft lure being received between the hook ends and secured by the teeth along the bait securing shank portion.

FIG. 9 illustrates a front view of another preferred embodiment of the present invention in a closed configuration.

FIG. 10 illustrates a back view of the preferred embodiment of FIG. 9.

FIG. 11 illustrates a side view of the preferred embodiment of FIG. 9, showing that the pair of shanks are in line.

FIG. 12 illustrates an angled view or perspective view of the preferred embodiment of FIG. 9.

FIG. 13 illustrates a front view of another preferred embodiment of the present invention in a closed configuration, wherein the biasing spring is a smaller coil compared to the biasing spring of FIG. 14.

FIG. 14 illustrates a front view of another preferred embodiment of the present invention in a closed configuration, wherein the biasing spring is a larger coil compared to the biasing spring of FIG. 13.

FIG. 15 illustrates a front view of another preferred embodiment of the present invention in a closed configuration, wherein the handle portion is shorter compared to the handle portion of FIG. 16.

FIG. 16 illustrates a front view of another preferred embodiment of the present invention in a closed configuration, wherein the handle portion is longer compared to the handle portion of FIG. 15.

### DESCRIPTION OF THE INVENTION

Preferred embodiments of the invention will now be described with reference to the accompanying drawings and non-limiting examples.

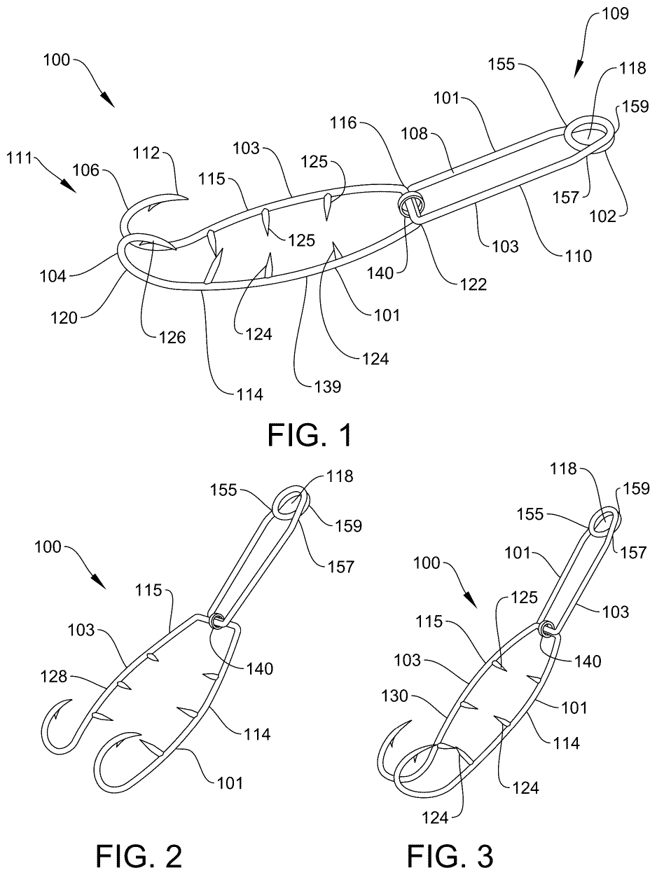

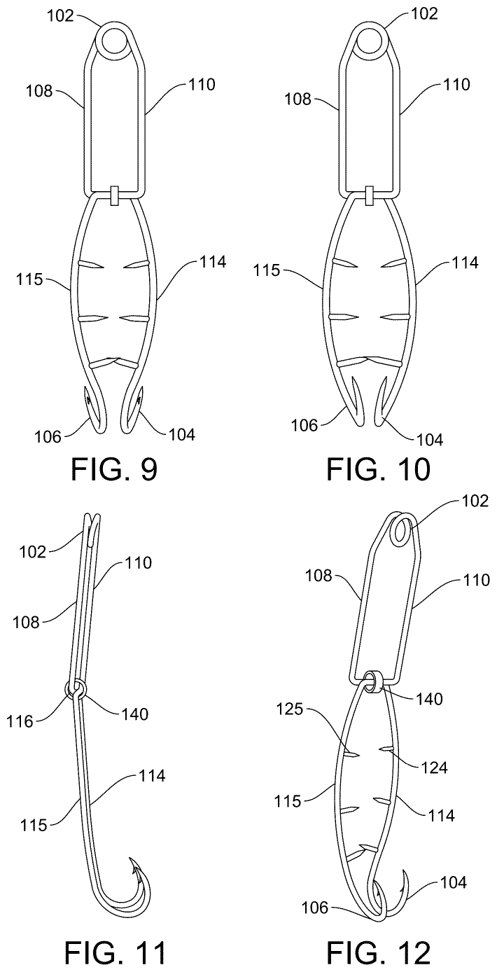

In an embodiment of the present invention, as illustrated in FIGS. 1 to 16, FIG. 1 shows a fishing device 100 or fishing apparatus 100 according to a preferred embodiment of the present invention. The fishing device 100 may comprise a first elongate member 101 parallel to a second elongate member 103, which act as a bait retaining arms. The first elongate member 101 and the second elongate member 103 are each connected to a respective end 157, 155 of a biasing spring 102 at a first end 109.

The first elongate member 101 and the second elongate member 103 each has a respective hook being a first hook 104 and a second hook 106 formed at a second ends 111 respectively. The device 100 may have a crossing region 116 or a handle bend 116 positioned between the first end 109 and the second end 111, and which is between the first elongate member 101 and second elongate member 103. The crossing region 116 may separate each elongate member 101, 103 into a shank portion and a handle portion.

More particularly, in relation to the first elongate member 101, the crossing region 116 separates the elongate member into a first shank portion 114, and a first handle portion 108; and in relation to the second elongate member 103, the crossing region 116 separates the elongate member into a second shank portion 115, and a second handle portion 108. For securing the first elongate member 101 and the second elongate member 103 at the crossing region 106, there may be a retaining element 140, The retaining element 140 may be circular, as shown in FIGS. 1 to 3, or the retaining element 140 may have retaining slots that allows the crossing region 116 to move therethrough until it reaches the bending regions 116, 122 of the shank portions 114, 115.

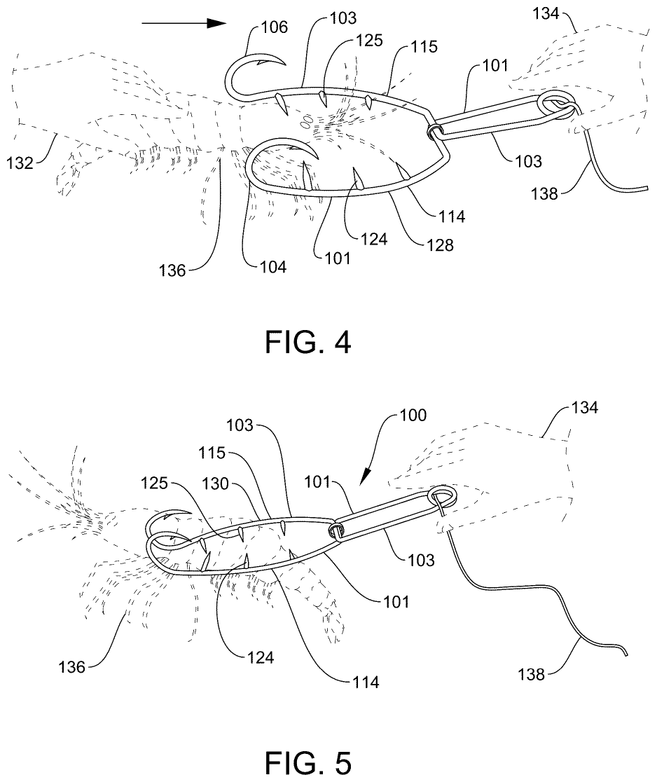

A first group of teeth 124 and a second group of teeth 125 each group of teeth having at least one tooth adapted for securing bait. As shown in FIGS. 4-8, it shows how the group of teeth 124, 125 penetrates the bait and/or secures the bait 136 when received. The first group of teeth 124 from the first shank portion 114 may be protruding from the surface towards the second shank portion 115, and similarly, the second group of teeth 125 from the second shank portion 115 may be protruding from the surface towards the first shank portion 114.

The fishing device 100 may be operable between an open configuration 128, as shown in FIGS. 2 and 4; and a closed configuration 130, as shown in FIGS. 3 and 5.

The open configuration 128 may be effected by applying a squeezing force or a pinching force where as shown in FIG. 4, for example, a person's thumb may be engaging with a second handle portion 110 and a person's index finger may be engaging with a first handle portion 108. It may be appreciated that as long as the first handle portion 108 and the second handle portion 110 are moved relatively closer to each other from the biased position, the first shank portion 114 is moved away from the second shank portion 115. This open configuration 128 allows a bait 136, depicted as a prawn as an example can be received into the bait receiving zone such that when the bait 136 is between the first shank portions 114 with the first group of teeth 124, and the second shank portion 115 with the second group of teeth 125, the groups of teeth 124. 125 help retain and secure the bait 136. It is safer for a person attaching bait to this fishing device 100 compared to ones that require the hook to be thread through the mouth and into the bait's body.

This device 100 reduces the risk of the hooks possibly puncturing a person's hand 132 or fingers when securing bait. Further, the teeth 124, 125 help secure and retains the bait 136 through penetrating or impaling the bait 136 so that when a person is fishing, and have to fling the device 100 with the secured bait 136 into the water, the flinging force may not allow the bait 136 to be flung or casted out of the device 100.

The shank portions 114, 115 are biased towards each other in a closed position 130 so when the bait 136 is received in the bait retaining zone, removal of the squeezing or pinching force allows the biasing spring 102 to move the handle portions 108, 110 away to its original distance away from each other, which in turn moves the first shank portion 114 and the second shank portion 115 back to its original distance away from each other.

In an another preferred embodiment of the present invention, the groups of teeth 124, 125 may be in a different configuration (not shown). The first group of teeth 124 from the first shank portion 114 may be protruding at an angle towards the second shank portion 115. The angle may be acute or obtuse with respect to the length of the elongate member. The angled teeth configuration may assist a person in securing the bait 136 as the person's hand 132 is pushing the bait into the zone. It is most preferable that the angle of the first group of teeth is perpendicular from the first shank portion 114, in which the first group of teeth 124 is in the direction going towards the second shank portion 115.

In another preferred embodiment of the present invention, as shown in FIGS. 1 to 3, the protrusion of the first group of teeth 124 may be in line with respect to the second group of teeth 125 that is perpendicular from the second shank portion 115, in which the second group of teeth 125 may be in the direction going towards the first shank portion 114. In another preferred embodiment of the present invention, the protrusion of the first group of teeth 124 may be off-set with respect to the second group of teeth 125 that is perpendicular from the first shank portion 114, in which the first group of teeth 124 is in the direction going towards the second shank portion 115. Similarly, the protrusion of the second group of teeth 125 is also perpendicular from the second shank portion 115, in which the second group of teeth 125 may be in the direction going towards the first shank portion 114.

It is preferable on securing the bait 136 that the first group of teeth 124 is equally spaced from each other so that there is a tooth 124 to secure the bait at equal points along the length of the bait 136. Similarly, the second group of teeth 125 is also equally spaced from each other so that there is a tooth 125 from the second shank portion 115 to secure the bait 136 at equal points along the length of the bait 136 at another side. It may be preferable to have the length of the teeth 124/125 protrusion decrease in length from the second end 111 towards the crossing region 116.

The biased spring 102 may have a first end 155 and a second end 157, wherein the first end 109 of the first elongate member 101 is in connection to the second end 157 of the biased spring 102, and wherein the first end 109 of the second elongate member 115 is in connection to the first end 155 of the biased spring 102. The biased spring 102 may be a coiled portion at the first end 109, wherein the profile of the eye of the coil 118 is in the same longitudinal plane as the fishing device 100. The coiled portion 102 may have one or more rings 159, wherein the profile of each ring is in the same plane as the longitudinal axis of the device 100. The eye of the coil 118 also serves to allows a fishing line to be received therethrough and tied through the eye of the coil 118 so that the tied fishing device 100 can be secured to the fishing line and not be removed as a person flings their fishing line to the water when casting.

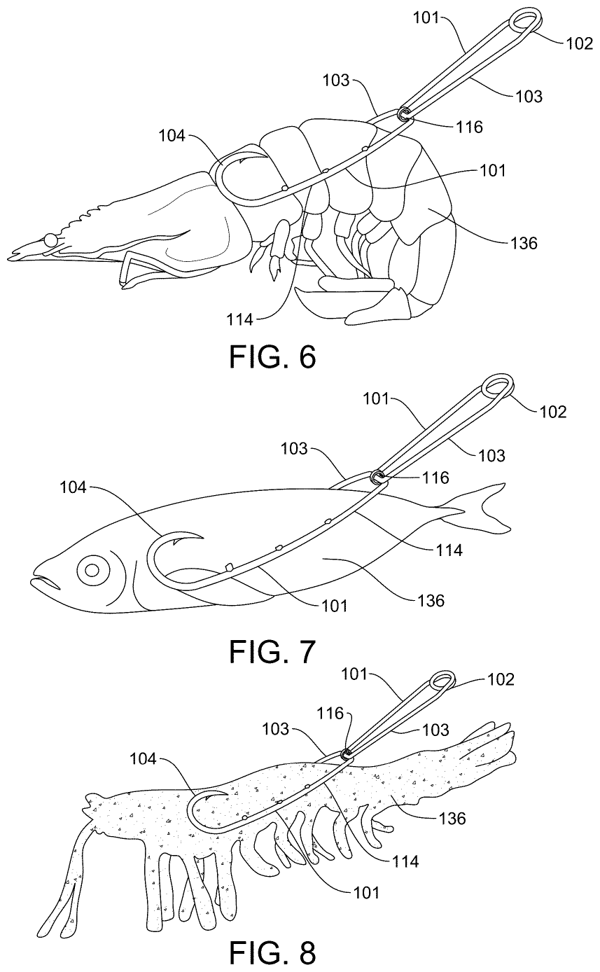

It may be appreciated that certain baits 136 will have to be secured more tightly or more loosely than others and the spring tension can be catered or tailored for use with securing certain baits. For example, a softer squishier bait may require sufficient tension but not so much so as to mash the bait 136 between the two shank portions 114, 115 when in a closed configuration 130 or a bait securing configuration 130. In this case, a biasing spring 102 may be of a certain predetermined tension may be attained through using a larger spring 102 with a larger coil eye diameter 118 for reducing tension. For example, a larger sturdier bait 136 such as a small fish 136 may require a higher tension to grip and secure the bait 136 to the device 100. In this case, a biasing spring 102 may be of a certain higher predetermined tension by using a smaller spring 102 with a smaller coil eye 118 diameter for reducing tension. Non-limiting examples of the types of baits 136 that are suitable for use with the fishing device 100 are shown in FIGS. 6 to 8.

There are two parts of the apparatus 100 that creates force or tension to close each side to hold the bait securely. By choosing the size of the spring 102, the tensions can be chosen or preferred to be used for a particular bait 136. This is important to when determining how much force is needed to hold the bait 136 by a hand 132 while still being easily opened by the second hand 134.

For example, as shown in FIG. 15, the shorter the handle portion lengths 108, 110 are between the biasing spring 102 and the crossing region 116, the more squeezing or pinching force a person is required to use to effect the shank portions 114, 115 in an open configuration 128. For example, as shown in FIG. 15, as the handle portions are shorter (relative to the device of FIG. 16), more squeezing or pinching force is required to be used. And as shown in FIG. 16, as the handle portions 108, 110 are longer (relative to the device of FIG. 15), less squeezing or pinching force is required to be used, It may be preferable and an advantage to have the length of the first shank portion 114 in a curved manner, as shown in FIGS. 1 to 3, which allows for fitting and or retaining the bait 136 better compared to a straight shank portion. The length of the first shank portion 114 and the length of the second shank portion 115 may have a convex profile.

The fishing device 100 may be constructed from a material selected from the group of: steel, stainless steel, and galvanized steel. For local or states that allow for the usage of stainless steel fishing devices 100, stainless steel may be useful and making the fishing device 100 last longer when an angler spends a lot of time fishing in saltwater.

While some local or states allow for the usage of stainless steel fishing device or hook for fishing, in certain local or states, there may be a ban on stainless steel in consideration of fish welfare, where stainless steel hooks may be lodged in the fish's throat if a person or a fisherman have cut the line. Due to the non-rusting nature of stainless steel, if it does get lodged in the fish's throat, it will not deteriorate quickly enough within the fish for it to survive. As such, the fishing device may be constructed for a rustable material, such as pure iron, steel or galvanised steel, which can comply with the particular countries and/or local or state fishing regulations. While the device can be constructed from high-carbon steel, the carbon-steel fishing device will be stronger than the stainless-steel. When catching a big and strong fish, an advantage is that the carbon-steel is capable of bending under heavy strain, while a stainless-steel fishing device at the hook end might break. Other materials may be preferred such as the fishing device constructed of steel alloyed with vanadium which provides lightness and their increased strength compared to steel.

As shown in FIG. 1, the first hook 104 and the second hook 106 may each have at least one barb 126 below the point of the hook. The barb 126 may prevent the hook 104/106 or hooks 104, 106 from coming back out of the fish's mouth. While barbed hooks may increase the success of fishing, if the fish does unhook themselves, the barbs 126 are more likely to damage the fish permanently. Should a fish break away with a barbed hook, it must wait for the hook to rust off instead of dropping out eventually.

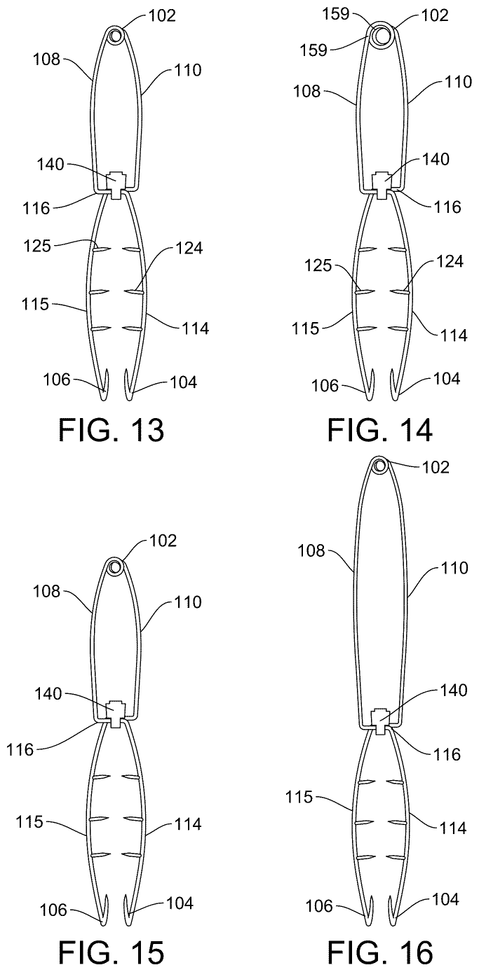

While some countries and/or some local or state regulations may not have rules regarding the use of barbed hooks, this fishing device 100 can have barbs 126 near the point of the hook 112 for use in countries or waters that are in the jurisdiction of the countries that does not prohibit this use. For local or states that do have rules prohibiting the use of barbed hooks, barb-less hook embodiments as shown in FIGS. 13 to 16 can also be manufactured for use in those particular areas.

As shown in FIG. 11, the hook may be a ‘J’ hook and the hook may be inline or offset with the shank portion. It may be appreciated that other non-limiting hook shapes can be used such as Aberdeen hooks, bait hooks, and circle hooks. While the slight offset hooks can increase the hooking percentages for an angler or a fisherman, due to local or state regulations, inline hooks may be used and offset hooks may not be allowed.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A fishing device adapted for securing bait, the fishing device comprising:
a first elongate member parallel to a second elongate member, wherein the first elongate member and the second elongate member are each connected to a respective end of a biasing spring at a first end; and wherein the first elongate member and the second elongate member each has a first hook and second hook formed at a second end respectively;
a crossing region between the first elongate member and the second elongate member, wherein the crossing region separates each elongate member into a shank portion and a handle portion;
a retaining element for securing the crossing region of the elongate members;
a first group and a second group of teeth each group comprising at least one tooth adapted for securing bait, wherein the first group of teeth from the-a first shank portion is protruding towards the-a second shank portion, and wherein the second group of teeth from the second shank portion is protruding towards the first shank portion.

2. The fishing device according to claim 1, wherein the device is operable between an open configuration and a closed configuration, wherein the open configuration is effected by applying a squeezing force to the handle portion which moves the shank portions away from each other for allowing a bait to be received between the groups of teeth, and wherein releasing the squeezing force, the biasing spring biases the shank portions towards each other such that the teeth secures the received bait.

3. The fishing device according to any-e claims 1 to wherein the first group of teeth from the first shank portion is protruding at an angle towards the second shank portion, and wherein the second group of teeth from the second shank portion is protruding at an angle towards the first shank portion.

4. The fishing device according to any one of claims wherein the angle is perpendicular from the first shank portion towards the second shank portion.

5. The fishing device according to claim 4, wherein the protrusion of the first group of teeth is in line with respect to the second group of teeth.

6. The fishing device according to claim 5, wherein the protrusion of the tooth from the first group of teeth is offset with respect to the second group of teeth.

7. The fishing device according to claim 3, wherein the first group of teeth is protruding at an acute angle from the first shank portion, and wherein the second group of teeth is protruding at an acute angle from the second shank portion.

8. The fishing device according to claim 2, wherein the first group of teeth is protruding at an obtuse angle from the first shank portion, and wherein the second group of teeth is protruding at an obtuse angle from the second shank portion.

9. The fishing device according to claim 1, wherein the first group of teeth is equally spaced from each other, and the second group of teeth is equally spaced from each other, and wherein the length of the teeth protrusion decreases from the second end to the crossing region.

10. The fishing device according to claim 1, wherein the biasing spring is a coiled portion, wherein a profile of an eye of the coil is in the same longitudinal plane as the device.

11. The fishing device according to claim 10, wherein the coiled portion has one or more rings, wherein the profile of each ring is in the same plane as the longitudinal axis of the device.

12. The fishing device according to claim 10, wherein the eye of the coil is adapted to receive a fishing line therethrough.

13. The fishing device according to 12, wherein the size of the coil can be of a predetermined diameter for allowing the fishing device to be used in a range of tensions.

14. The fishing device according to claim 1, wherein the handle portion can be of a predetermined length for allowing the fishing device to be used in a range of squeezing forces for moving from the closed configuration to the open configuration.

15. The fishing device according to claim 1, wherein the biasing spring has a first end and a second end, wherein the first end of the first elongate member is in connection to the second end of the biasing spring, and wherein the first end of the second elongate member is in connection to the first end of the biasing spring.

16. The fishing device according to claim 1, wherein the first shank portion and the second shank portion is-are curved.

17. The fishing device according to claim 16, wherein the first shank portion and the second shank portion have a convex profile.

18. The fishing device according to claim 1, wherein the fishing device is constructed from a material selected from the group of: stainless steel, high-carbon steel, steel alloyed with vanadium, and galvanized steel.

19. The fishing device according to claim 1, wherein the first hook and the second hook each comprises a barb protruding from the surface of the hook.
